(19) United States
(12) Patent Application Publication
(10) Pub. No.: US 2008/0009176 A1
(43) Pub. Date: Jan. 10, 2008

(54) Connecting device for lamp mount for lamp bracket

(76) Inventor: Hanzhong Yang, Shenzhen (CN)

Correspondence Address: FRANK F. TIAN, 331-4A THIRD AVENUE, LONG BEACH, NJ, 07740, US

(21) Appl. No.: 11/374,376

(22) Filed: Mar. 13, 2006

(51) Int. Cl. H01R 4/24; H01R 13/66

(52) U.S. Cl. 439/404; 439/535

(57) ABSTRACT

A connector for lamp bracket is provided. The connector includes a female connecting sleeve with a plughole; and a first shaft hole, defined in the female connecting sleeve, with the first shaft hole sharing a commonly shared predetermined space or communicated with the plughole. A camshaft rotatably disposed in the first shaft hole. The camshaft comprising a flange screwably disposed within the plughole.

### FIELD OF THE INVENTION

The present invention relates to connecting devices, more particularly to a lamp connecting device incorporating connectors with integrated simplified configuration resulting in firm or secure connection.

### BACKGROUND OF THE INVENTION

As known to those who are skilled in the art, a lamp typically comprises a lamp mount and a bent pipe. The lamp mount can be either a center mount or a wall mount with the mount supporting the lamp bracket, which has a bulb mounted thereon. The existing method for connecting the lamp mount and the lamp bracket employs a turnbuckle to fix a bent pipe to the lamp mount. However, this connecting method incurs a large package volume of the lamp and a high cost associated therewith. Besides, the lamp mount and the lamp bracket can also be connected by spring pressing. For example, a lamp connecting device and lamp bracket, disclosed in PRC Patent No. CN01232084.6, Publication No. CN2508106Y, can be detached and assembled quickly, and are convenient for users to install. However the lamp bracket may sway slightly.

At present, the method for connecting wires between the lamp mount and the lamp bracket comprises connecting leads of each lamp bracket by two or more terminals which may be screw-in type (PE-type) terminals or closed-end (CE-type) terminals. The wire connecting method adopting terminals takes up a certain space, thus limiting the size of the lamp mount, and affecting an otherwise fine appearance.

Accordingly, a lamp connecting device having improved and simplified configuration which overcomes the above-mentioned problems is desired.

### SUMMARY OF THE INVENTION

The present invention provides a lamp mount and a suitable lamp bracket as well as an assembling method thereof, thereby overcoming the shortcomings of the existing technology.

Accordingly a compact lamp connecting device is provided.

Accordingly a connector for lamp bracket is provided. The connector includes a female connecting sleeve with a plughole; and a first shaft hole, defined in the female connecting sleeve, with the first shaft hole sharing a commonly shared predetermined space or communicated with the plughole. A camshaft rotatably disposed in the first shaft hole. The camshaft comprising a flange screwably disposed within the plughole.

Additionally, a lamp connecting device is provided. The lamp connecting device includes a female connecting sleeve with a plughole; a male connecting sleeve, comprising a terminal block inserted into the plughole of the female connecting sleeve together with the male connecting sleeve; a female rigid sleeve attaching mechanism, disposed on the female connecting sleeve; and a male sleeve rigid attaching mechanism, disposed on the male connecting sleeve and fastened with the female sleeve rigid attaching mechanism.

In a preferred embodiment, as a female sleeve rigid clipping fastener catches a male sleeve rigid clipping fastener in a simple way, rapid detachment and assembly can be realized. In addition, the package volume is small, so it is convenient for transportation, thus reducing the cost. Also, a rigid connecting method is adopted, and the two parts are mated closely and fixedly connected with each other. As a pin or a camshaft catches a shaft hole or a groove, it is convenient to assemble. The present invention adopts a camshaft to locate the left and right, front and back positions, and an internal hexagonal screw to press against the upper surface of the male connection sleeve to locate the upper and lower positions, so as to tightly mate the bent pipe and the center socket. As an electrical wire is connected to the conductive terminals of the junction boxes, it is unnecessary to connect the junction boxes with helical or closed-end terminals, thereby saving the internal space of the lamp mount and reducing the size of the lamp mount.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is an exploded view of the lamp connecting device in accordance with a preferred embodiment of the present invention comprising a housing, a cover, a connector, a female connecting sleeve, a camcraft, a positioning plate, a junction box, a male sleeve, conductive terminal, and at least one plastic member.

FIG. 2 is a spatial exploded view of the lamp mount according to the invention.

FIG. 3a is a spatial view of the connector for lamp bracket according to the invention.

FIG. 3b is a spatial view of the female connection sleeve according to the invention.

FIG. 3c is a front view of the female connection sleeve according to the invention.

FIG. 4a is a spatial view of the camshaft.

FIG. 4b is a front view of the camshaft.

FIG. 4c is a top view of the camshaft.

FIG. 5a is a spatial view of the positioning plate.

FIG. 5b is a bottom view of the positioning plate.

FIG. 5c is a sectional view along Line B-B of the positioning plate.

FIG. 6a is a spatial exploded view of the junction box in a first state.

FIG. 6b is a spatial exploded view of the junction box in a second state.

FIG. 6c is a spatial view of the junction box.

FIG. 7a is a spatial view of the electrical wire male sleeve.

FIG. 7b is a rear view of the male sleeve for electrical wires.

FIG. 7c is a front view of the male sleeve for electrical wires.

FIG. 7d is a right view of the male sleeve for electrical wires.

FIG. 7e is a partial sectional view of the conductive stab terminal.

FIG. 8a is a spatial view of the plastic pressing tab.

FIG. 8b is a half-sectional view of the plastic pressing tab.

FIGS. 9a and 9b are spatial views of the female sleeve for electrical wires from a first and a second view angle.

FIG. 10 is a spatial view of a housing.

FIG. 11 is a spatial view of a cover.

FIG. 12 is a spatial exploded view of the structure of the lamp bracket.

FIGS. 13a and 13b are spatial views of the male connection sleeve from a first and a second view angle.

FIG. 13c is a sectional view of the male connection sleeve.

FIG. 14 is a schematic view of assembling multiple connectors for lamp bracket in an electrical wire.

FIG. 15 is a schematic view of joining the connector for lamp bracket, the junction box, and the male connection sleeve.

FIG. 16 is a schematic view of assembling the lamp mount and the lamp bracket.

FIG. 17 is a schematic view of the male connection sleeve catching the camshaft.

FIG. 18a is a sectional view of the female connection sleeve according to the second embodiment of the invention.

FIG. 18b is a spatial view of the male connection sleeve according to the second embodiment of the invention.

FIG. 19a is a front view of the female connection sleeve according to the third embodiment of the invention.

FIG. 19b is a sectional view of the female connection sleeve along Line C-C according to the third embodiment of the invention.

FIG. 19c is a front view of the male connection sleeve according to the third embodiment of the invention.

FIG. 19d is a sectional view of the male connection sleeve along Line D-D according to the third embodiment of the invention; and

FIG. 20a is a perspective view of the male connection sleeve according to the fourth embodiment of the invention.

### DETAILED DESCRIPTION OF THE INVENTION

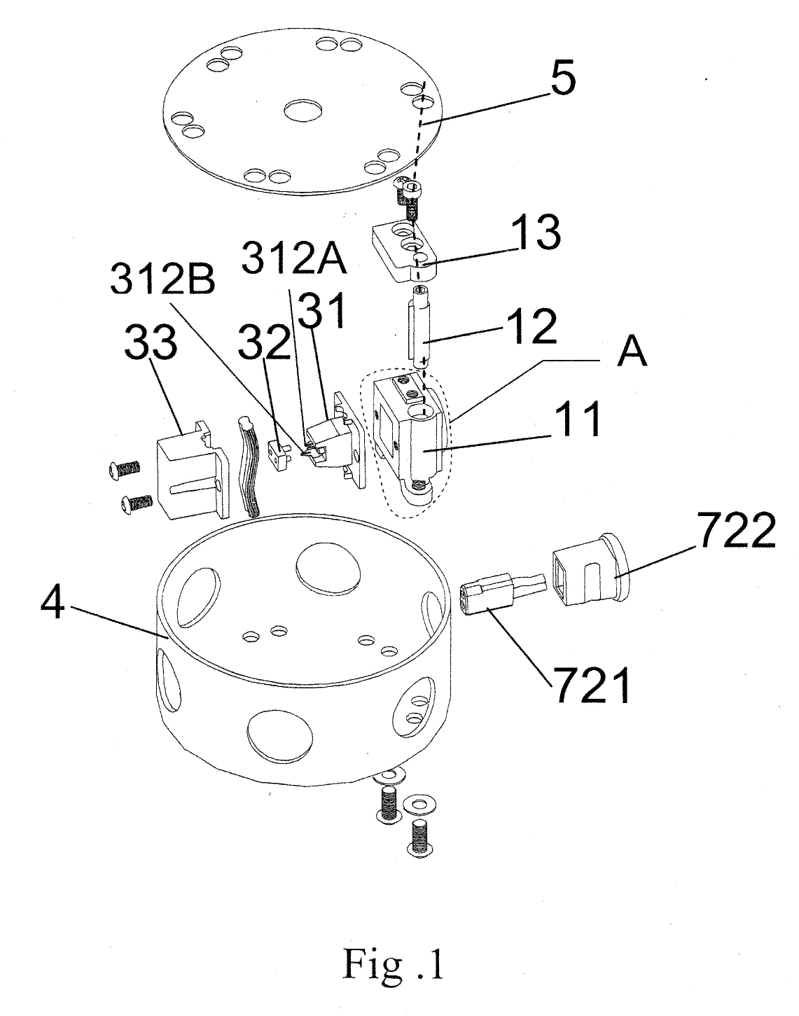

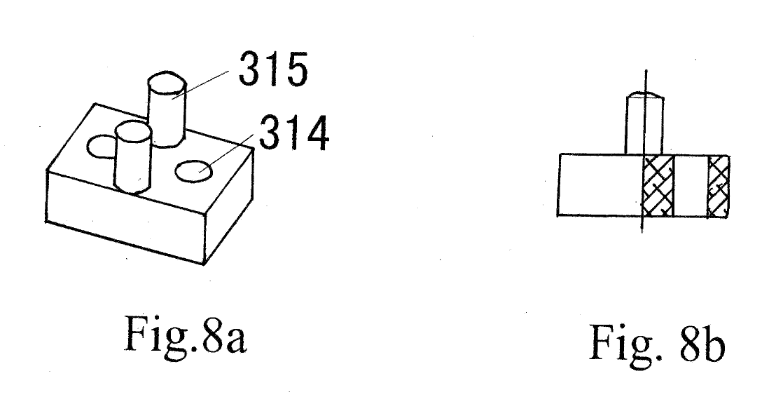

Referring to FIGS. 1-20, the present invention is described by various preferred embodiments.

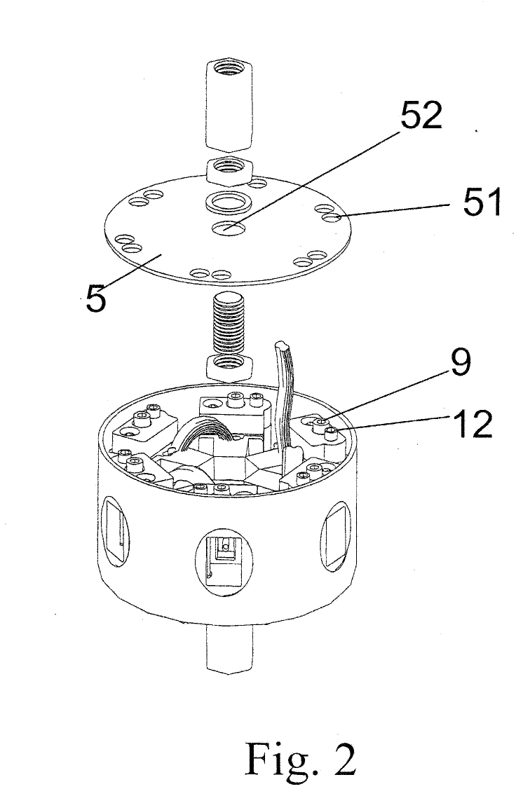

A lamp mount comprises a connector for lamp bracket 6, a junction box 3, and housings 4, 5 is provided. As shown in FIGS. 1 and 2, the connector for lamp bracket 6 comprises a female connecting sleeve 11, a camshaft 12, a positioning plate 13, an internal hexagonal screw, and a screw. The junction box comprises a male sleeve 31 for electrical wires, a plastic member 32, conductive terminals 312A, 312B, and a female sleeve 33 for electrical wires.

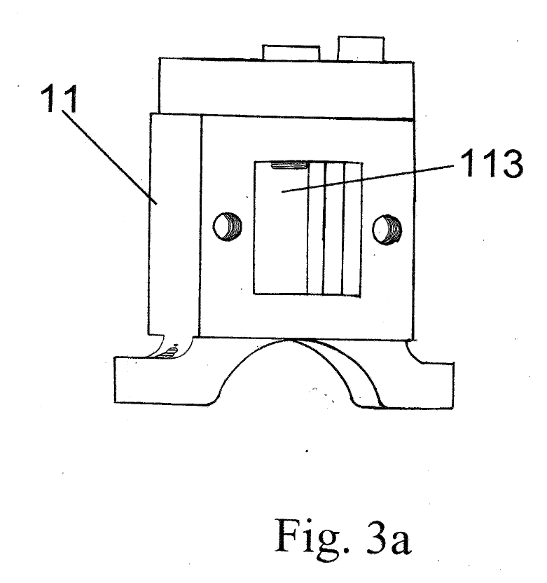

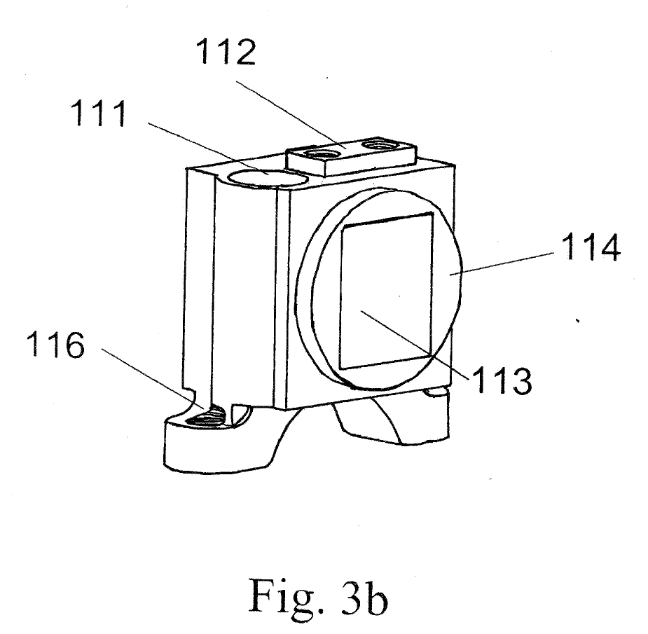

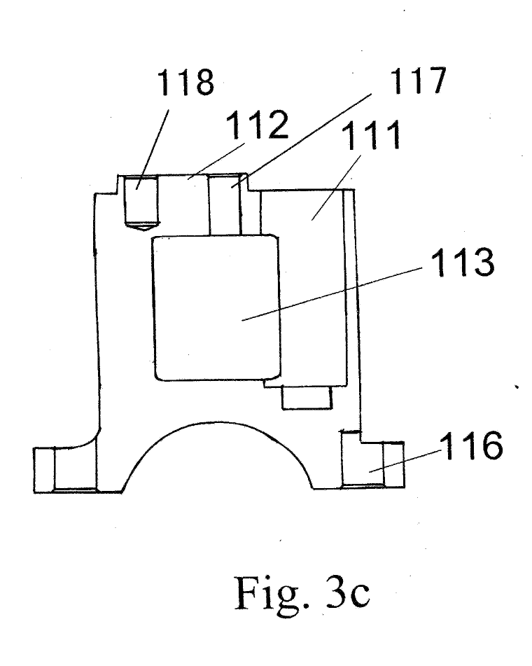

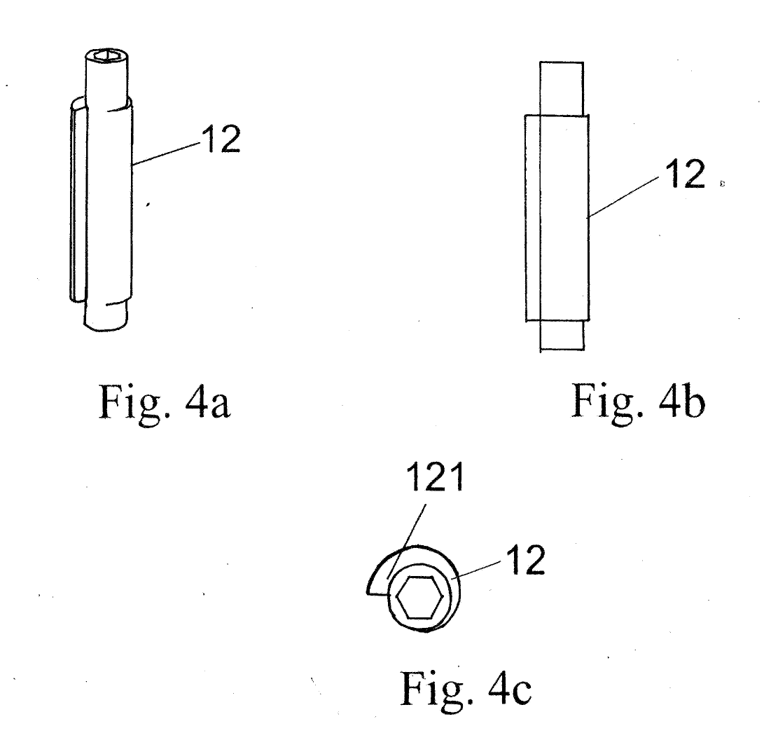

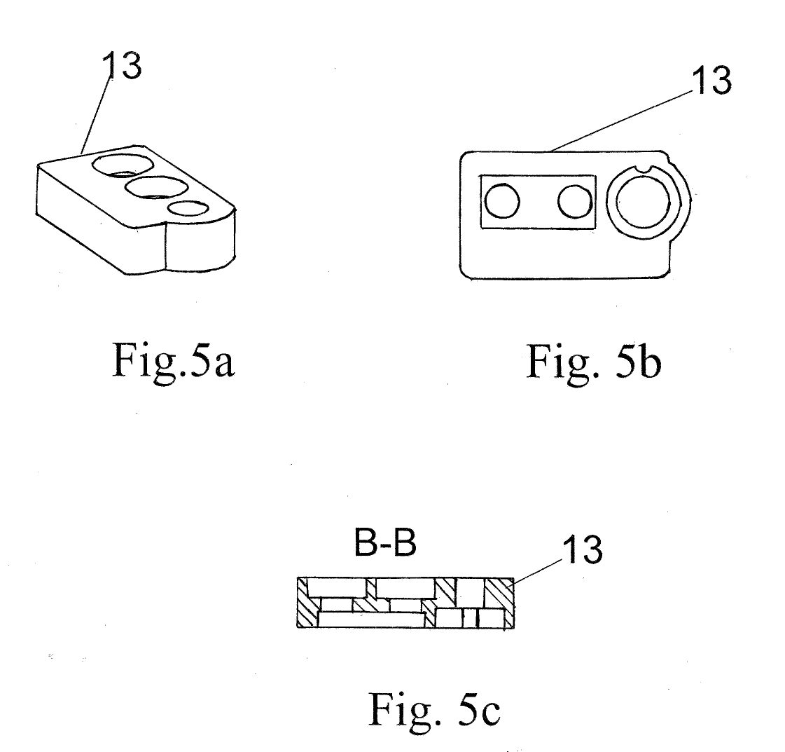

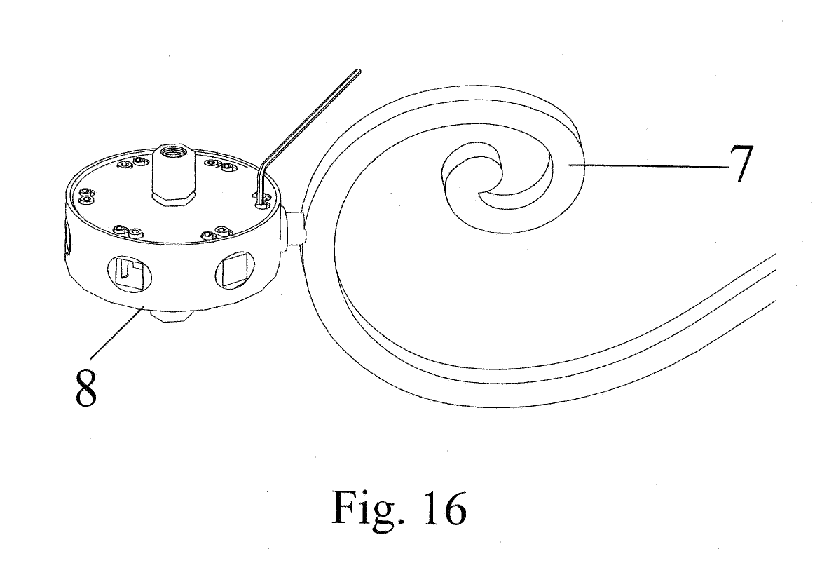

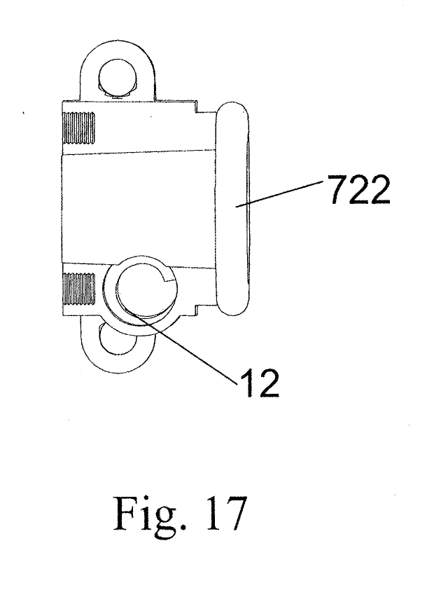

As shown in FIGS. 3a, 3b, and 3c, a sink 111 is formed at one side of the female connecting sleeve 11. A positioning block 112, a third fixing hole 117, and a fourth fixing hole 118 are disposed at the top of the female connecting sleeve 11, wherein the third and the fourth fixing holes 117, 118 are screw holes. As shown in FIGS. 5a, 5b, and 5c, the shape of the abutted surface of the positioning plate 13 fits that of the female connecting sleeve 11. The positioning plate 13 defines a camshaft positioning hole 132, a second positioning hole 133, and a fifth fixing hole 134. There is a positioning groove 131 at the bottom of the positioning plate 13. The positioning block 112 is embedded in the positioning groove 131. The two screw holes 133, 134 are positioned in the positioning block 112, wherein the third fixing hole 117 adjacent to the sink 111 is an internal hexagonal screw hole. An internal hexagonal screw (not shown) functions as a fixing leg inserted in the second positioning hole 133 in the positioning plate 13 and the internal hexagonal screw hole 133. The internal hexagonal screw moves along the direction perpendicular to the plughole 113, so as to be slightly or partially screwed into the plughole 113. Thereby the internal hexagonal screw presses against the upper surface of the male connecting sleeve 722 for rigidly affixing the female connecting sleeve 11 and the male connecting sleeve 722 in the up and down direction. The camshaft 12 is put into the sink 111. The sink 111 and the camshaft constitute a female sleeve rigid clipping fastener. After the camshaft 12 is put into the sink 111 of the female connecting sleeve 11, a part of the arc bulge in the middle of the camshaft 12 is exposed, and the exposed arc bulge 121 is embedded in the camshaft positioning hole 132 in the positioning plate 13. There are two screw holes 116 at the bottom of the female connecting sleeve 11. Screws (not shown) pass through the screw holes 116 to fix the female connecting sleeve 11 onto the housing 4. A screw (also not shown) goes through the fifth fixing hole 134 in the positioning plate 13 and the fourth fixing hole in the female connecting sleeve 11 to lock the positioning plate 13 onto the female connecting sleeve 11. The middle part of the female connecting sleeve 11 defines a plughole, i.e., a square hole 113, and the male connecting sleeve 722 is inserted into the square hole 113. A first boss 114 protrudes from the square hole at the back of the female connecting sleeve 11, and is embedded in a side hole of the housing 4. As shown in FIGS. 4a, 4b, and 4c, there is an arc bulge 121 in the middle of the camshaft 12. As shown in FIGS. 16 and 17, the bulge 121 catches the slot of the male connecting sleeve 722 for suitable positioning. Shaft necks are disposed at the top and the bottom of the camshaft 12, wherein an internal hexagonal hole is in the middle part of one of the shaft necks. An internal hexagonal spanner (not shown) can be inserted into the shaft neck with the internal hexagonal hole, and is rotated to screw the arc bulge 121 of the camshaft 12 in the slot of the male connecting sleeve 722, so as to tightly fasten the female connecting sleeve 11 and the male connecting sleeve 722 in the front and back, left and right directions.

In the above embodiment, a female rigid sleeve attaching mechanism comprises at least one positioning plate (see FIGS. 5a-5c), at least one sink 111, at least one camshaft 12, and at least one internal hexagonal screw 9.

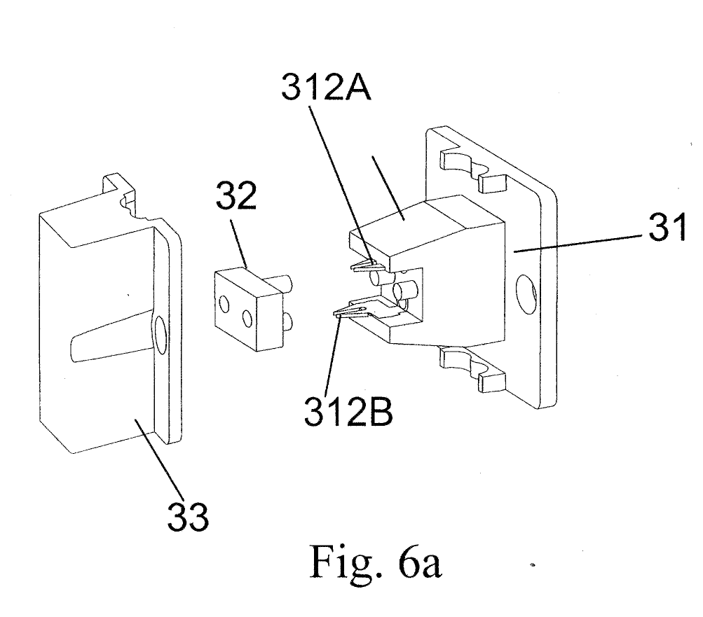

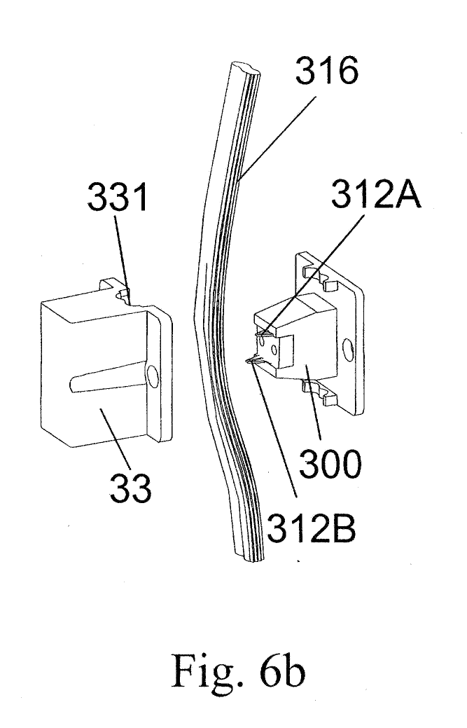

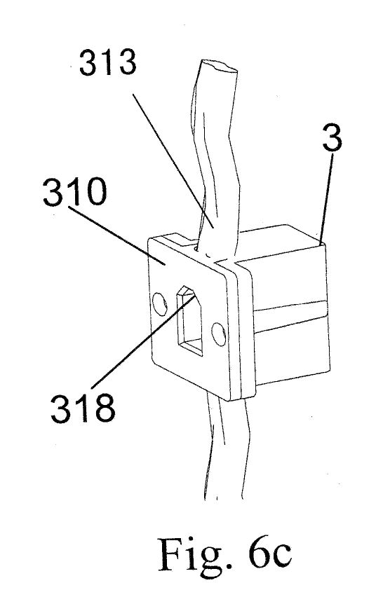

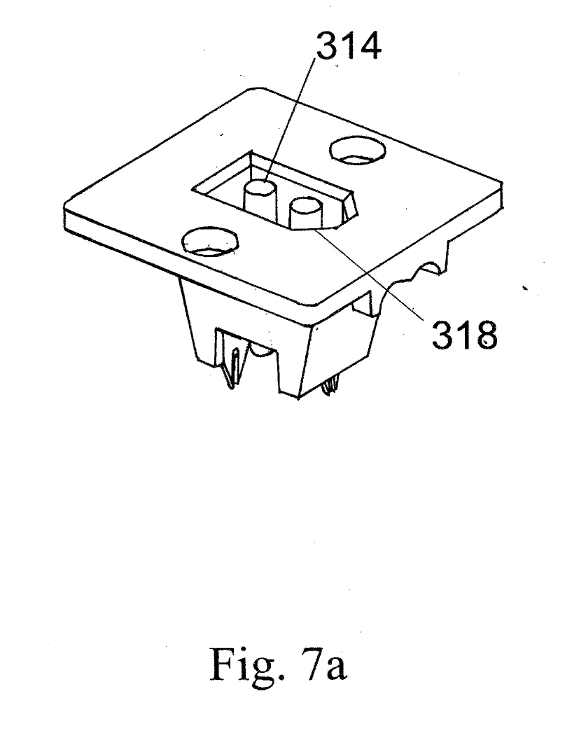

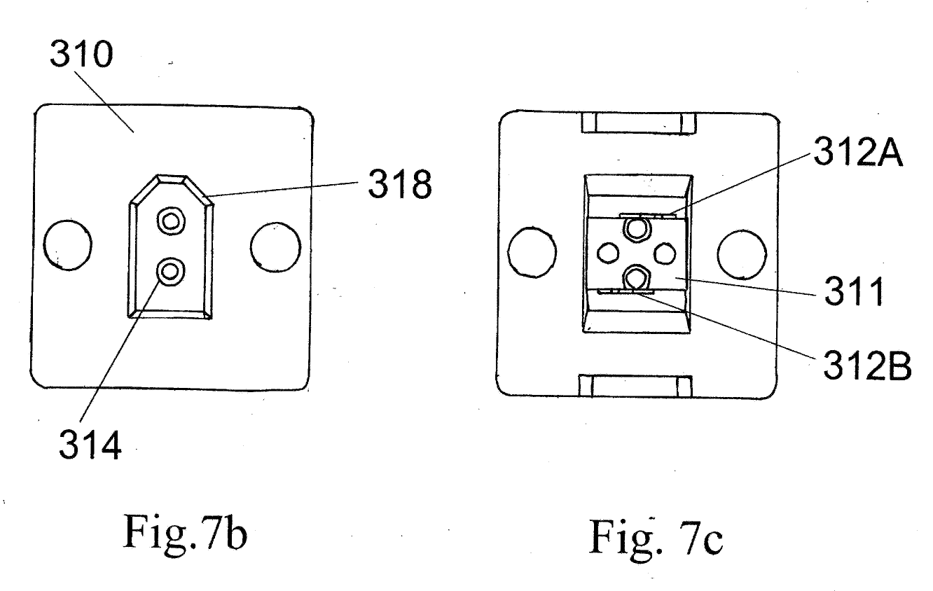

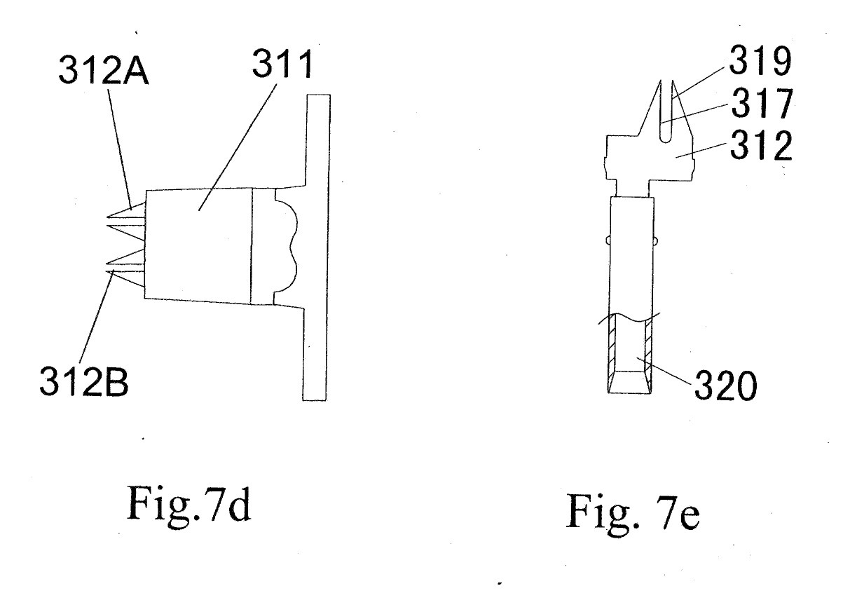

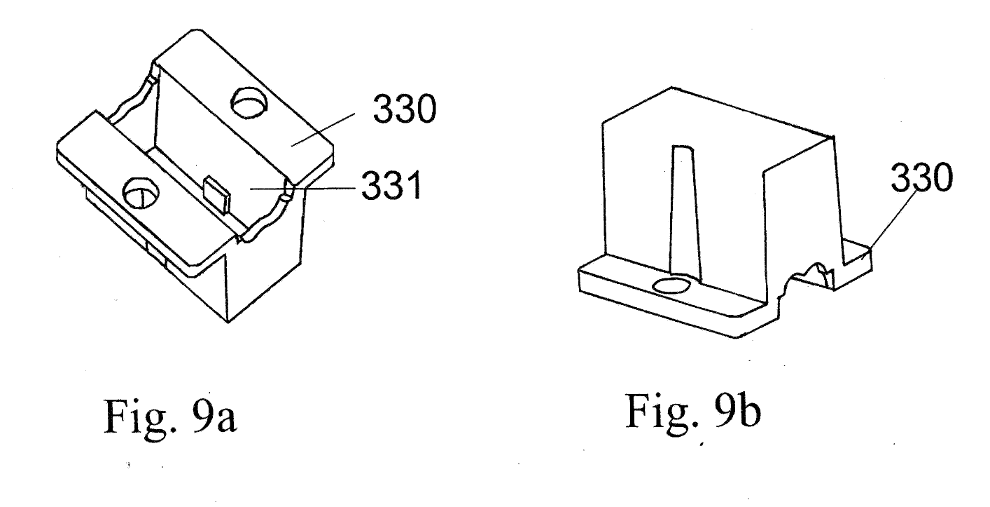

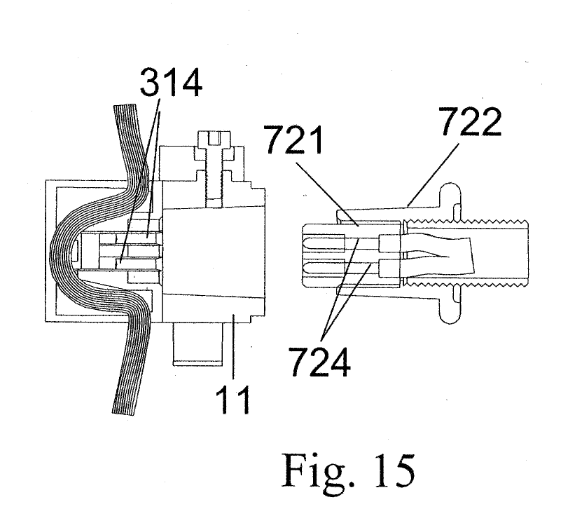

As shown in FIGS. 6a-6c, the junction box 3 comprises a male sleeve 31 for electrical wires, a plastic member 32, conductive terminals 312A, 312B, a lead 316, and a female sleeve 33 for electrical wires. As shown in FIGS. 7a, 7d, and 7e, the male sleeve 31 for electrical wires comprises a second boss 311 with two holes. The second boss 311 has a groove in the front end, and a second fixing shaft 314A and a sixth fixing hole 315A are disposed in the groove. A wiring slot 317 protrudes from the pointed conductive terminal, and the bare wires of the leads are fixed in the wiring slot 317. Stabs protrude upward from the sidewall of the wiring slot 317, thus constituting a stab end 319 for piercing the isolation layer of the electrical wire. Wiring terminals 320 further protrude from the conductive terminals 312A, 312B, wherein the wiring terminals 320 are hollow columns respectively fixed in two holes in the second boss 311. The two conductive terminals 312A, 312B are spaced apart by a predetermined distance, so as to prevent the conductive terminals from piercing the electrical wire, thereby causing a short circuit. For convenience of piercing, the horizontal distance between the two conductive terminals is approximately equal to the center distance of the lead. As shown in FIG. 15, the bare wires in the terminal blocks are disposed in a hollow column or inner space. The wiring terminals 320 are electrically connected to the terminal blocks. A plastic member 32 comprises a third fixing shaft 315B and a seventh fixing hole 314B. The second fixing shaft 314A and the third fixing shaft 315B are respectively inserted into the seventh fixing hole 314B and the sixth fixing hole 315A, for pressing the plastic member 32 in the groove of the male sleeve for electrical wires 31. The stab ends 319 protrude from the aperture between the pressing tab and the male sleeve for electrical wires. As shown in FIGS. 7b and 7c, an opening with a beveled end 318 is disposed at the back of the male sleeve for electrical wires 31. a terminal block 721 is inserted into a corresponding hole. The beveled end 318 is used to position the positive and negative electrodes of the electrical wire. As shown in FIGS. 9a and 9b, the female sleeve for electrical wires is a hollow housing, matching and covering the male sleeve for electrical wires.

As shown in FIG. 6c, a spacing hole 313 is disposed in the junction box. As shown in FIG. 6b, wire channels are formed at the junction of the male connecting sleeve and the female connecting sleeve. A spacing hole 313 is defined by closing the wire channels. The lead is fixed in the spacing hole.

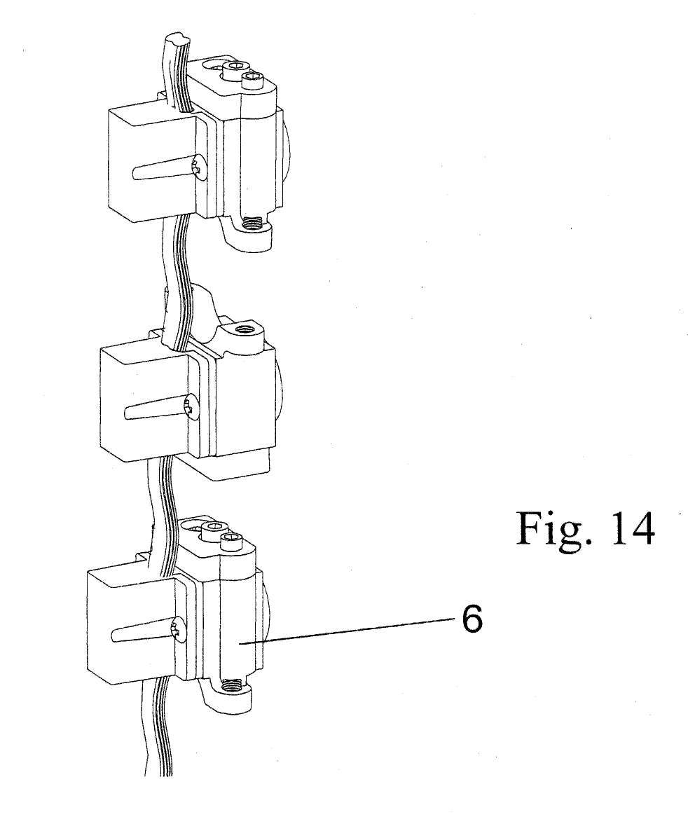

As shown in FIG. 14, multiple junction boxes are engaged with a wirehaving leads being respectively connected respectively to the wiring slots 317 in the junction boxes.

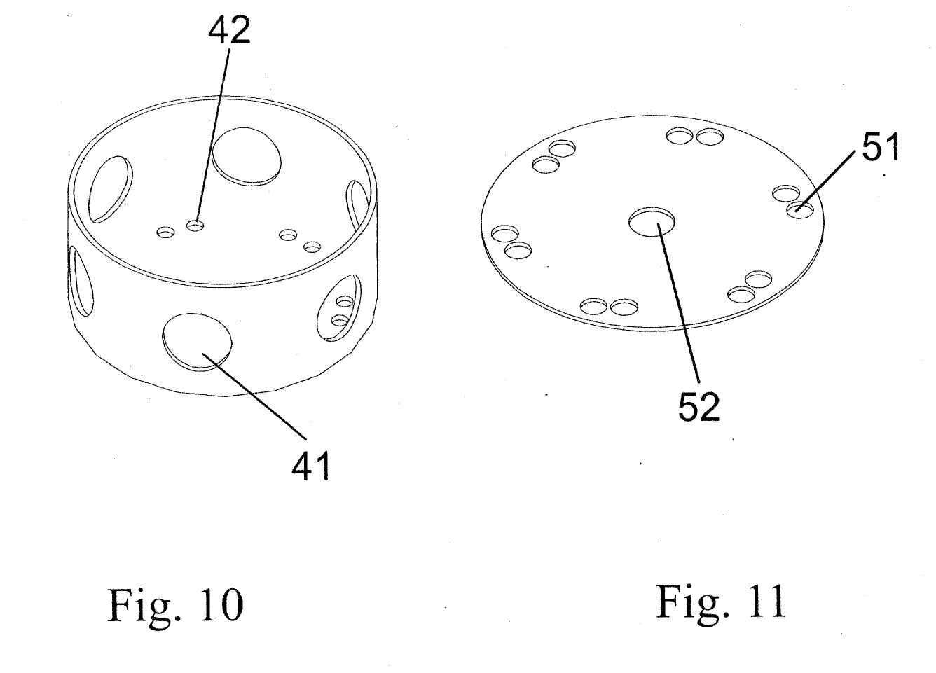

As shown in FIG. 10, side holes 41 are disposed in the sidewall of the housing 4, wherein the first boss 114 of the female connecting sleeve 11 is embedded into a side hole 41. The third positioning holes 42 are uniformly defined at or distributed among the periphery of the bottom of the housing 4 corresponding to the screw holes at the bottom of the female connecting sleeve 11. A fourth positioning hole (not shown) is defined in the middle of the housing 4, having the end portion of the electrical wire passes through the fourth positioning hole. As shown in FIG. 11, the fifth positioning holes 515 are uniformly defined at distributed among the periphery of the housing 5, corresponding to the positions of the sink and the internal hexagonal screw hole of the female connecting sleeve 11. A sixth positioning hole 52 is defined in the middle of the housing 5, and the electrical outgoing line goes through the sixth positioning hole 52. As shown in FIGS. 2 and 16, the housings 4 and 5 are locked via connecting elements, such as screws, nipples, internal tooth lock washers, and at least one bonding post. The camshaft 12 and the top of the internal hexagonal screw 9 extend out of the fifth positioning hole 51 of the housing 5, and the electrical outgoing line extends out of the sixth positioning hole 52 of the housing 5.

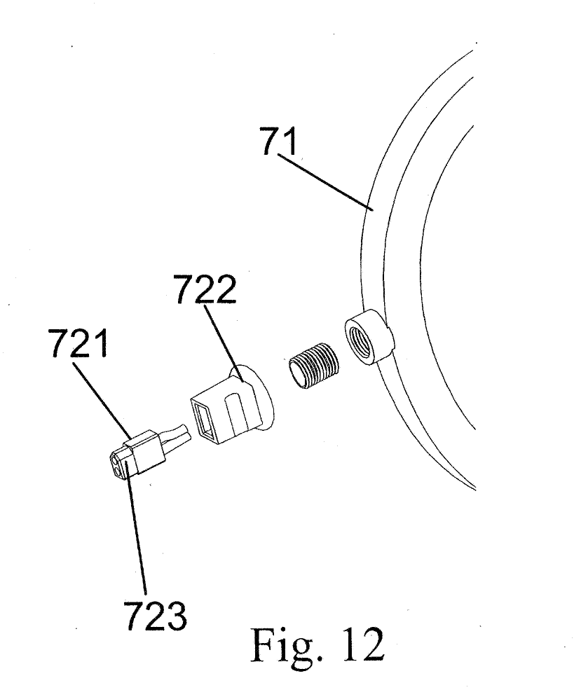

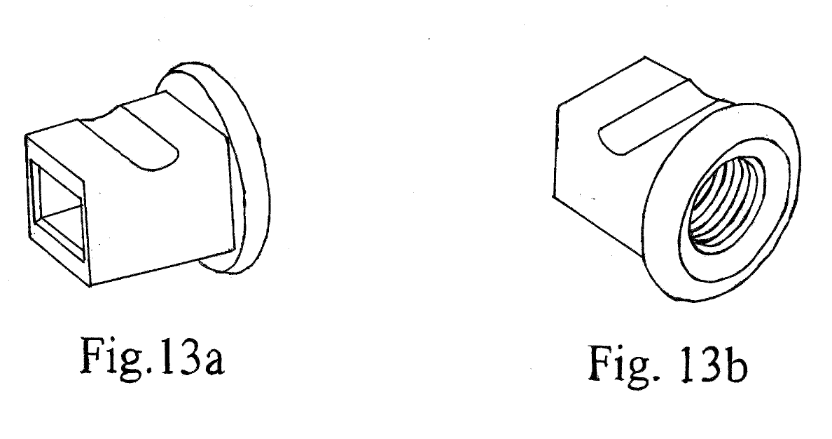

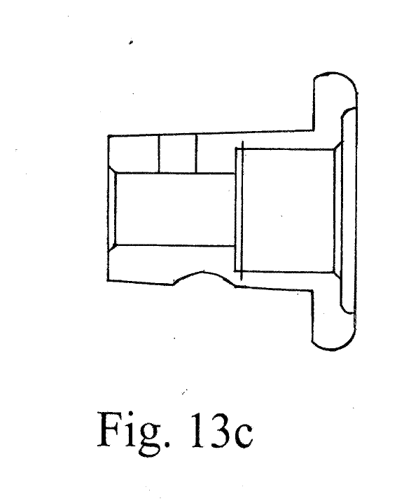

As shown in FIG. 12, a lamp bracket comprises a bent pipe 71, a terminal block 721, and a male connecting sleeve 722. As shown in FIGS. 13a, 13b, and 13c, an arc slot is formed at one sidewall of the male connecting sleeve 722, and the arc slot is a male sleeve rigidly attaching mechanism. The front end of the male connecting sleeve 722 may be a hollow rectangular hole, while the back end thereof may be a hollow cylindrical hole. The terminal block 721 is inserted through the rectangular hole and the cylindrical hole of the male connecting sleeve 722. The male connecting sleeve 722 is tightly connected to the bent pipe 71 via a hollow nipple. The electrical wire of the terminal block 721 goes through the male connecting sleeve 722, and the hollow nipple, then into the bent pipe 71, so as to electrically connect the bulb on the bent pipe.

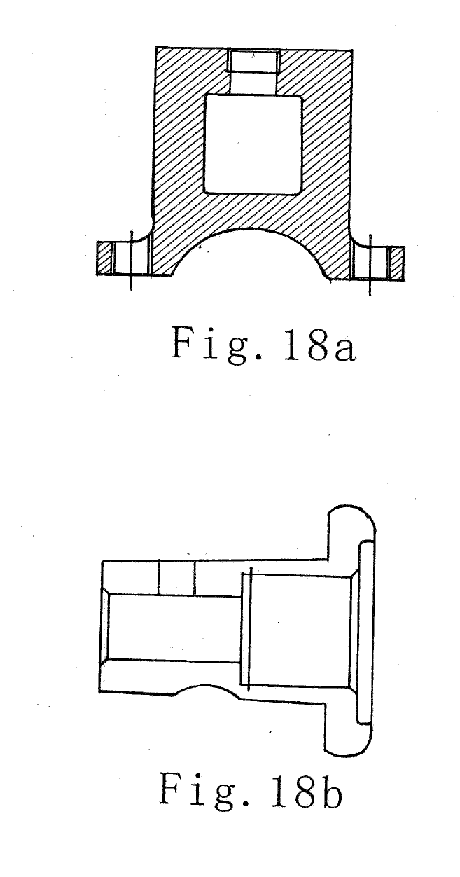

As shown in FIGS. 18a and 18b, different from the other embodiments, in the second embodiment of the invention, the connector for lamp bracket 6 comprises a female connecting sleeve 11 and a screw. A first shaft hole is provided in the direction perpendicular to the plughole of the female connecting sleeve, i.e. a screw hole 81. The sidewall of the male connecting sleeve 722 is not provided with a slot thereon, but with a second shaft hole 82. When the male connecting sleeve is inserted into the plughole of the female connecting sleeve 11, the screw hole in the female connecting sleeve corresponds to the second shaft hole in the male connecting sleeve. The screw is a plug-in member inserted into the second shaft hole 82 in the male connecting sleeve and screwed in the screw hole 81 in the female connecting sleeve tightly, for the purpose of fastening the female connecting sleeve and the male connecting sleeve together.

In the above mentioned embodiments, the screw and the first shaft hole fixed on the female connecting sleeve constitute the female sleeve rigid attaching mechanism. The male sleeve rigid attaching mechanism comprises a second shaft hole and a screw inserted therein.

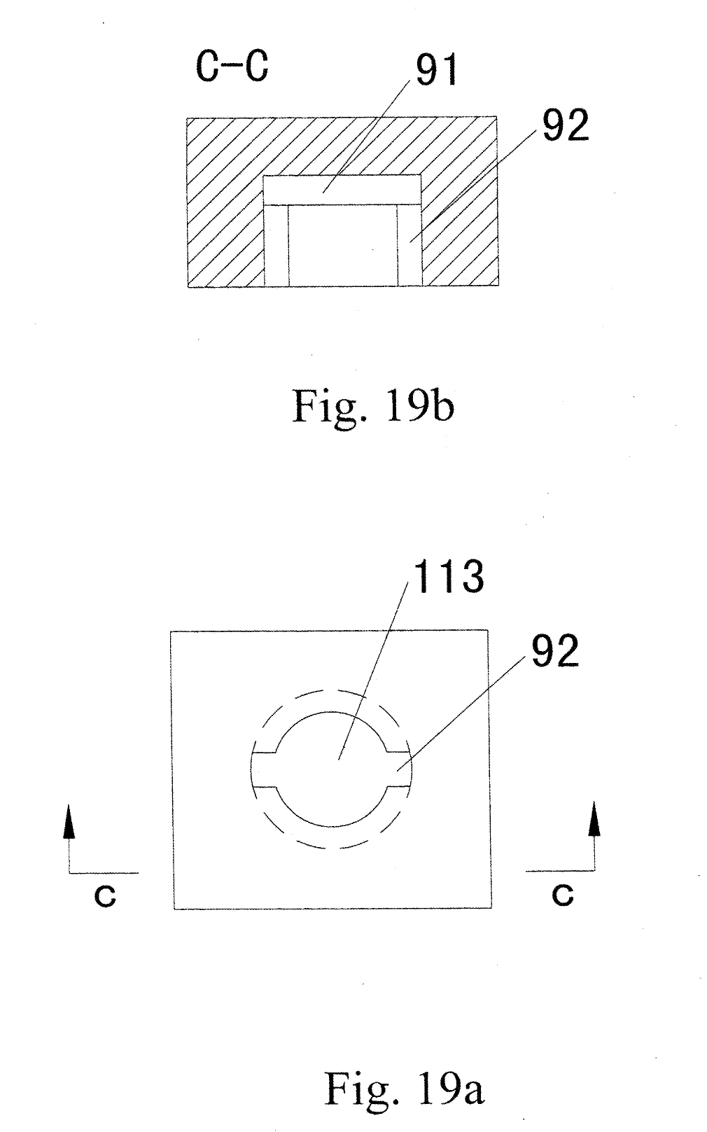

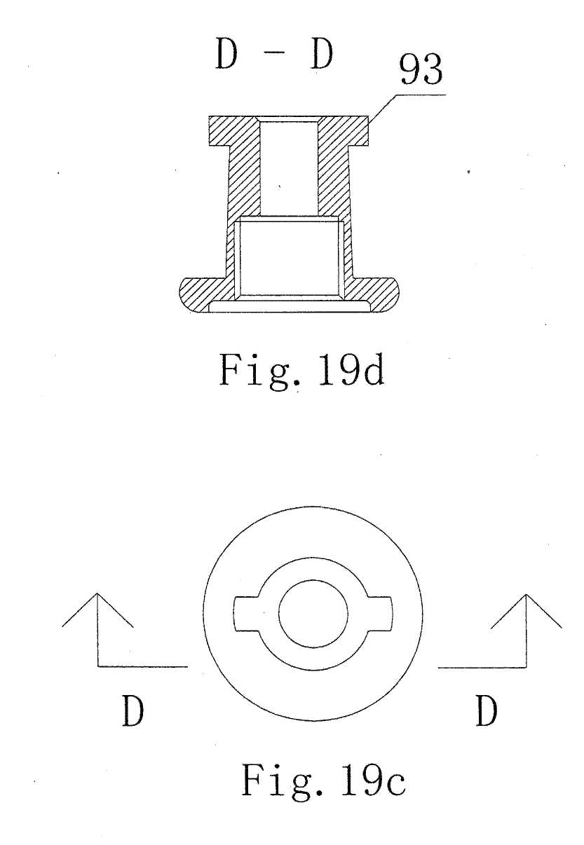

As shown in FIGS. 19a, 19b, and 19c, different from the other embodiments, in the third embodiment of the invention, the connector for lamp bracket comprises a female connecting sleeve. The plughole comprises a cylindrical hole. A guide slot 92 and a slot 91 are defined on the sidewall of the plughole of the female connecting sleeve. The guide slot 92 extends from the insert end of the plughole into the slot along the axial direction. As shown in FIG. 19d, the end of the male connecting sleeve is of a cylindrical shape. Clipping tabs 93 are distributed symmetrically along the external circumference of the cylinder. When the male connecting sleeve is inserted into the plughole of the female connecting sleeve 11, the clipping tabs 93 on the male connecting sleeve are inserted into the plughole of the female connecting sleeve along the guide slot 92. When the clipping tabs 93 are moved to the slot 91, the female connecting sleeve and the male connecting sleeve are rotated relatively, thereby making the male connecting sleeve and the female connecting sleeve tightly fastened together.

The guide slot and the slot defined on the female connecting sleeve constitute the female sleeve rigid attaching mechanism, and the clipping tabs on the male connecting sleeve constitute the male sleeve rigid attaching mechanism.

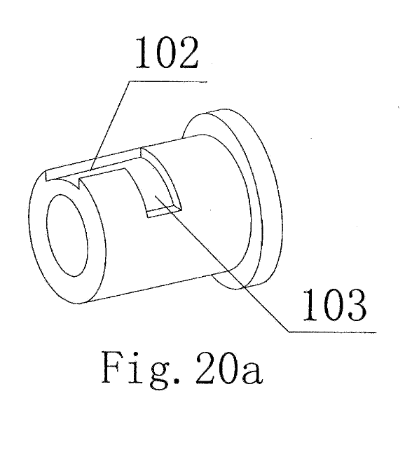

As shown in FIG. 20a, different from the other embodiments, in the fourth embodiment of the invention, the connector for lamp bracket comprises a female connecting sleeve. The plughole in the female connecting sleeve is a cylindrical hole, and clipping tabs are disposed on the inner sidewall of the plughole (not shown). There is a guide slot 102 and a slot 103 disposed in the male connecting sleeve, and the guide slot axially extends from the insert end to the annular slot 103.

The clipping tabs on the female connecting sleeve constitute the female sleeve rigid attaching mechanism. The guide slot 102 and the slot 103 on the male connecting sleeve constitute the male sleeve rigid attaching mechanism.

While the present invention has been illustrated by the description of the preferred embodiments thereof, and while the preferred embodiments have been described in considerable detail, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative examples shown and described

1. A connector for lamp bracket, comprising: a female connecting: sleeve with a plughole; and a first shaft hole, defined in the female connecting sleeve, with the first shaft hole sharing a commonly shared predetermined space or communicated with the plughole.

2. The connector for lamp bracket according to claim 1 further comprising a camshaft, rotatably disposed in the first shaft hole, the camshaft comprising a flange screwably disposed within the plughole.

3. The connector for lamp bracket according to claim 2, wherein the female connecting sleeve comprises a third fixing hole communicated with the plughole, and a fixing leg movably secured in the third fixing hole along the direction perpendicular to the plughole.

4. The connector for lamp bracket according to claim 3, further comprising a positioning plate fixed on the female connecting sleeve, the positioning plate comprising a camshaft positioning hole and a second positioning hole, the fixing leg going through the second positioning hole, and the camshaft partially disposed in the camshaft positioning hole.

5. A lamp connecting device, comprising: a female connecting sleeve with a plughole; a male connecting sleeve, comprising a terminal block inserted into the plughole of the female connecting sleeve together with the male connecting sleeve; a female rigid sleeve attaching mechanism, disposed on the female connecting sleeve; and a male sleeve rigid attaching mechanism, disposed on the male connecting sleeve and fastened with the female sleeve rigid attaching mechanism.

6. The lamp connecting device according to claim 5, wherein the male sleeve rigid attaching mechanism and the female sleeve rigid attaching mechanism are rotatably fastened together.

7. The lamp connecting device according to claim 5, wherein the female sleeve rigid ataching mechanism comprises a first shaft hole defined on the female connecting sleeve and communicated with the plughole; the male sleeve rigid attaching mechanism comprises a slot defined on the male connecting sleeve and a plug-in member inserted in both the slot and the first shaft hole.

8. The lamp connecting device according to claim 7, wherein the plug-in member is a camshaft rotatably received in the first shaft hole, the camshaft comprises a flange received into the slot.

9. The lamp connecting device according to claim 6, wherein the female sleeve rigid attaching mechanism comprises a first mounting member selected from the group consisting of a slot or a clipping tab, and the male sleeve clipping mechanism comprises a second mounting member in correspondence to the first mounting member selected from the group consisting of a slot or a clipping tab.

10. The lamp connecting device according to claim 9, wherein the first and second mounting members are disposed on the sidewall of the plughole, a guide device is disposed on the inner sidewall of the plughole, the guide device extends from a selected member of the group consisting of the male connecting sleeve or the female connecting sleeve to the clipping tab.

11. The lamp connecting device according to claims 5, further comprising a junction box, the junction box comprising a male sleeve for electrical wires, a conductive terminal fixed on the male sleeve, a wiring terminal extend from the conductive terminal, a wiring slot defined in the conductive terminal, and a lead, the wiring terminal electrically connected with the terminal block, bare wires inside the lead electrically coupled with the conductive terminal and fixed in the wiring slot.

12. The lamp connecting device according to claim 11, wherein a stab end protrudes upward from a sidewall of the wiring slot.

13. The lamp connecting device according to claim 11, wherein a plurality of junction boxes is engaged together via the plural bare wires of the lead each of which is respectively disposed to the wiring slots in the junction boxes.

14. The lamp connecting device according to claim 13, wherein each of the junction boxes defines a mounting hole with an opening, and the lead is received in the mounting hole.

15. The lamp connecting device according to claim 14, wherein the male sleeve for electrical wires comprises a plurality of holes, a plurality of conductive terminals; the wiring terminal is respectively received in the hole of the male sleeve, each of the junction boxes further comprises a pressing tab leaning against the male sleeve, and the stab end sticks out from the aperture between the pressing tab and the male sleeve; an electrical wire female sleeve covering the male sleeve.

16. The lamp connecting device according to claim 15, wherein the mounting hole is defined at the junction of the male sleeve for electrical wires and the electrical wire female sleeve.

17. The lamp connecting device according to claim 16, wherein the female connecting sleeve comprises a third fixing hole intercommunicated to the plughole, and a fixing leg, the leg is mounted in the third fixing hole with the third leg disposed to move along the direction perpendicular to the plughole; a positioning plate fixed on the female connecting sleeve, comprises a positioning groove, a camshaft positioning hole, and a second positioning hole; the fixing leg goes through the second positioning hole, and the camshaft is partially disposed in the positioning hole of the camshaft; a positioning block is formed at top of the female connecting sleeve, and embedded in the positioning groove; the male sleeve for electrical wires defines a groove, the holes in the male sleeve for electrical wires are defined in the groove, and a pressing tab is compressed in the groove.

18. A lamp connecting device comprising: a female connecting means with a plughole; a male connecting means, comprising a terminal block inserted into the plughole of the female connecting means together with the male connecting means; a female rigid sleeve attaching means, disposed on the female connecting means; and a male sleeve rigid attaching means, disposed on the male connecting means and fastened with the female sleeve rigid attaching means.
